(19) United States
(12) Patent Application Publication
(10) Pub. No.: US 2025/0262584 A1
(43) Pub. Date: Aug. 21, 2025

(54) NOx REMOVAL FOR CRYOGENIC CARBON CAPTURE FROM FLUE GAS

(71) Applicant: UOP LLC, Des Plaines, IL (US)

(72) Inventors: Evan B. Jorgenson, Elgin, IL (US); Jeffrey Tyska, Roselle, IL (US); Kathryn R. Bjorkman Marrou, Mount Prospect, IL (US)

(21) Appl. No.: 18/926,486

(22) Filed: Oct. 25, 2024

Related U.S. Application Data
(60) Provisional application No. 63/554,456, filed on Feb. 16, 2024.

(51) Int. Cl. B01D 53/00; B01D 3/14; B01D 53/047; C01B 32/50; F25J 3/02

(52) U.S. Cl. CPC B01D 53/002; B01D 3/143; B01D 53/047; C01B 32/50; F25J 3/0266; B01D 2256/22; B01D 2257/402; B01D 2257/404; B01D 2257/504; B01D 2258/0283; F25J 2200/72; F25J 2210/70; F25J 2215/80; F25J 2220/84; F25J 2245/02

(57) ABSTRACT

Processes for recovery of carbon dioxide from a flue gas stream and removal of NOx compounds from the recovered carbon dioxide are described. The processes can recover gaseous, liquid, or supercritical carbon dioxide. The processes incorporate a NOx stripping column after the CO₂ fractionation column to remove NOx compounds formed in the CO₂ fractionation column.

### RELATED APPLICATIONS

This application claims priority to U.S. Provisional Patent Application Ser. No. 63/554,456, filed on Feb. 16, 2024, the entirety of which is incorporated herein by reference.

### BACKGROUND

CO₂ capture from flue gas is a key decarbonization strategy for various industries, such as steel, power and cement producers. Flue gas has contaminants that will cause the CO₂ product to be off specification (e.g., NO₂, SO₂, etc.) or cause issues in the PSA-cryogenic system such as mercury issues with brazed aluminum exchanger, etc. The CO₂ capture technologies need to handle the various contaminants in the feed while minimizing the corresponding energy usage and cost.

In cryogenic carbon capture from a flue gas or other source with NOx compounds present, separation of NOx from the captured CO₂ for sequestration or utilization is highly important. Under certain circumstances and for tight product specifications, the removal of NO₂ upstream of the cryogenic fractionation column may be inadequate to remove NO₂ to the levels required due to the continued reaction of NO and O₂ to form NO₂ in the cryogenic fractionation column and overhead system.

There is a need for processes which efficiently capture CO₂ in gas feed streams, as well as remove impurities from the feed streams and from the CO₂ product streams.

### BRIEF DESCRIPTION OF THE DRAWINGS

FIG. 1 illustrates one embodiment of a process producing a vapor phase carbon dioxide product according to the present invention.

FIG. 2 illustrates another embodiment of process producing a vapor phase carbon dioxide product according to the present invention.

FIG. 3 illustrates one embodiment of process producing a liquid or supercritical phase carbon dioxide product according to the present invention.

FIG. 4 illustrates another embodiment of a process producing a liquid or supercritical phase carbon dioxide product according to the present invention.

### DESCRIPTION

This present invention provides processes to remove additional NOx compounds after the cryogenic CO₂ fractionation column. It addresses situations where removing the NOx compounds upstream of the CO₂ fractionation column is inadequate to remove NOx compounds to the levels required to meet the product specification. This is done while avoiding significant CO₂ product losses. The processes incorporate non-catalytic means of removing NOx while maintaining a vapor, liquid, or supercritical CO₂ product. NOx compounds include one or more or NO, NO₂, N₂O, N₂O₃, and N₂O₄.

This invention is embodied in two ways, depending on the desired CO₂ product phase. For both implementations, a NOx stripper column is added to strip off NOx from the CO₂ product from the bottom of the cryogenic fractionation column.

The liquid/supercritical product utilizes a higher pressure NOx stripper column (one or more) to increase the boiling point of the CO₂. The increased pressure allows the CO₂ feed to the NOx stripper column to be used as a condensing medium, saving on refrigeration system load. A pump and compressor are placed after a flash drum to increase the pressure accordingly. The CO₂ is then stripped in a NOx stripper column with the feed on the bottom tray and a liquid product is taken on the overhead to be sent to cooling or additional pumping as needed. The bottom stream is rich in NOx and is sent to the upstream NOx removal zone or a flue gas generating unit.

The vapor phase product implementation uses the same scheme, but the CO₂ feed from the CO₂ fractionation column (one or more) is sent directly to the NOx stripper column without an increase in pressure. The refrigeration system is used to condense the overhead, and a vapor only product is taken from the top. The bottoms stream is treated in the same manner as the liquid phase case.

In both cases, the reboiler is heated using either recirculating quench water from the quench column or warm refrigerant from the compressor discharge in the refrigeration loop.

Additionally, this process allows for low loss of CO₂ by recycling the significant amount of CO₂ purged with NOx to the NOx removal zone in the process where greater purification can take place at lower energy usage levels.

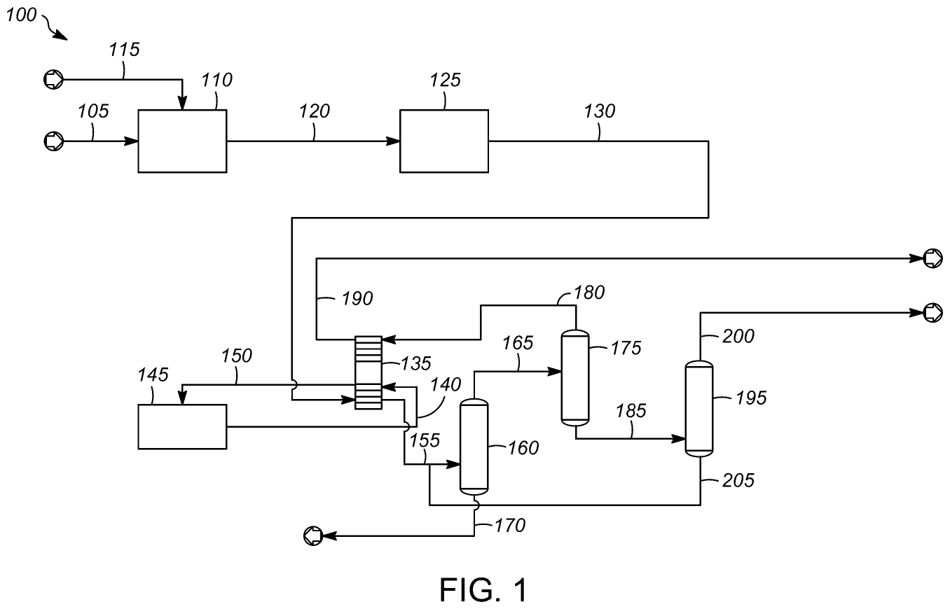

FIG. 1 illustrates one embodiment of a process 100 for producing a carbon dioxide vapor stream with reduced level of NOx compounds. A flue gas (or other gas) feed stream 105 comprises carbon dioxide, one or more NOx compounds, and one or more of nitrogen, oxygen, water and argon. The flue gas feed stream 105 may be sent to a quench column 110 where it is cooled with quench stream 115 in a quench column. The quench stream 115 can be any suitable quench stream as known to those of skill in the art. Suitable quench streams include, but are not limited to, water, caustic (to remove acidic impurities such as HCl and SO₂), or combinations thereof.

The quenched flue gas stream 120 is sent to a flue gas compressor and drier 125 where it is compressed and dried to form compressed flue gas stream 130. The quenched flue gas stream 120 is compressed from a pressure in a range of 75 to 150 kPa to a pressure in the range of 2500 to 5000 kPa for the compressed flue gas stream 130.

The compressed flue gas stream 130 is sent to the main heat exchanger 135 where it is cooled with a chilled refrigerant stream 140 from refrigeration system 145. The warmed refrigerant stream 150 is returned to the refrigeration system 145.

The cooled compressed flue gas stream 155 is sent to the NOx removal zone 160 comprising one or more NOx removal columns where the majority of the NOx compounds other than NO and N₂O are removed from the cooled compressed flue gas stream 155. The reduced contaminant stream 165 comprises carbon dioxide and a reduced level of NOx compounds compared to the cooled compressed flue gas stream 155 entering the NOx removal zone 160.

The NOx-enriched bottom stream 170 is highly concentrated in NOx compounds, typically 25-75 percent by mole. The NOx-enriched bottom stream 170 may be sent for treatment including, but not limited to, nitric acid production or fertilizer production. Alternatively, it may be combined with stream 190 and be discharged to the atmosphere, sent to further contaminant treating or a pressure swing adsorption unit.

The reduced contaminant stream 165 is sent to the CO₂ fractionation column 175 where it is separated into an overhead gas stream 180 comprising light components including, but not limited to, one or more of N₂, O₂, or NO, and a carbon dioxide-enriched bottom stream 185.

The overhead gas stream 180 may be warmed in the main heat exchanger 135, and the warmed overhead gas stream 190 may be sent to atmosphere, further flue gas contaminant treating, or a pressure swing adsorption unit.

During fractionation in the CO₂ fractionation column 175, a portion of the NO may be converted to NO₂, which leaves with the carbon dioxide-enriched bottom stream 185.

The carbon dioxide-enriched bottom stream 185 from the CO₂ fractionation column 175 is sent to the NOx stripping column 195 where the remaining NOx compounds are stripped from the carbon dioxide-enriched bottom stream 185. The stripping column overhead stream 200 comprises gaseous carbon dioxide and is depleted of NOx compounds. It is the gaseous carbon dioxide product stream. In some situations, it can be used to cool the upstream process if the temperature specification for the gaseous carbon dioxide product is sufficiently high.

The stripping column bottom stream 205, which is enriched in NOx compounds, is typically 0.1-5 mole percent NOx, and more often 0.2-1 mole % NOx. This stream may be recycled to the NOx removal zone 160 for concentration of the NOx and recovery of the CO₂, or to a flue gas generation unit (not shown) for destruction of the NOx and recovery of the CO₂.

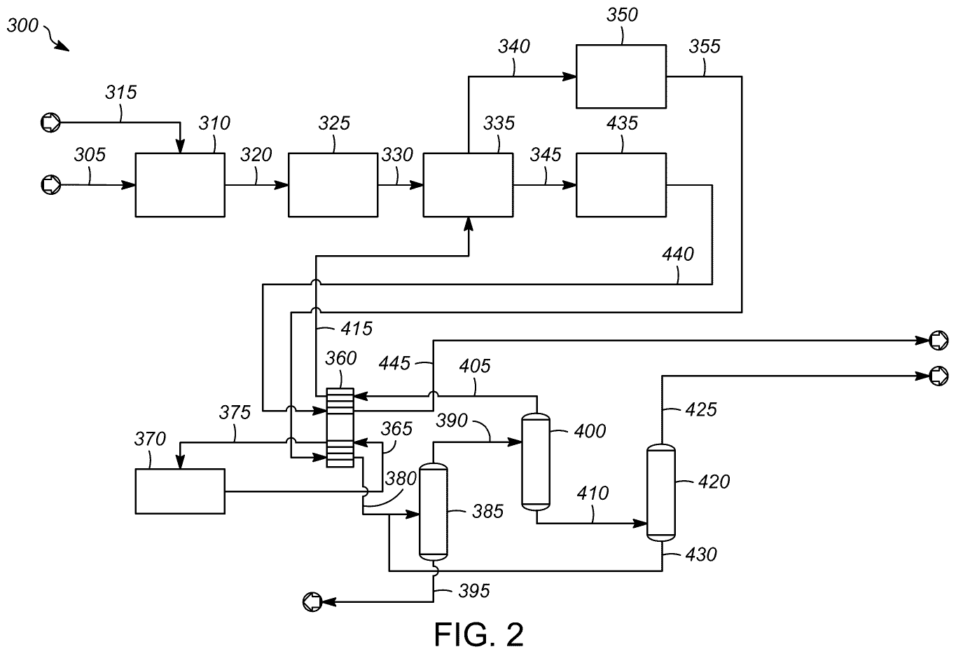

FIG. 2 illustrates a second embodiment of a process 300 for producing a carbon dioxide vapor stream with reduced level of NOx compound. The flue gas (or other gas) feed stream 305 comprises carbon dioxide, one or more NOx compounds, and one or more of nitrogen, oxygen, water and argon. The flue gas feed stream 305 may be sent to a quench column 310 where it is cooled with quench stream 315, as described above.

The quenched flue gas stream 320 is sent to a flue gas compressor 325 where it is compressed from a pressure in a range of 75 to 150 kPa to a pressure in the range of 800 to 2500 kPa.

The compressed flue gas stream 330 is sent to a CO₂ pressure swing adsorption (PSA) unit 335, which can be a standard CO₂ PSA unit or a CO₂ vacuum pressure swing adsorption (VPSA) unit. The compressed flue gas stream 330 is separated into a CO₂-enriched stream 340 and an off gas stream 345.

The CO₂-enriched stream 340 is sent to a compressor and dehydration unit 350 where it is compressed to a pressure in the range of 2500 to 5000 kPa and dried forming dried CO₂-enriched stream 355. The dehydration unit may comprise any suitable dehydration unit including, but not limited to, a triethylene glycol unit, an activated alumina or a silica gel or a molecular sieve (zeolite A or X) or a combination thereof-based temperature swing adsorption process.

The dried CO₂-enriched stream 355 is sent to the main heat exchanger 360 where it is cooled with a chilled refrigerant stream 365 from refrigeration system 370 forming cooled CO₂-enriched stream 380. The warmed refrigerant stream 375 is returned to the refrigeration system 370.

The cooled CO₂-enriched stream 380 is sent to the NOx removal zone 385 comprising one or more NOx removal columns where the majority of the NOx compounds other than NO and N₂O are removed from the cooled CO₂-enriched stream 380. The reduced contaminant stream 390 comprises carbon dioxide and a reduced level of NOx compounds compared to the cooled CO₂-enriched stream 380 entering the NOx removal zone 385.

The NOx-enriched bottom stream 395 is highly concentrated in NOx compounds, typically 25-75 percent by mole. The NOx-enriched bottom stream 395 may be sent for treatment including, but not limited to, nitric acid production or fertilizer production. Alternatively, it may be combined with stream 445 and be discharged to the atmosphere, sent to further contaminant treating or a pressure swing adsorption unit.

The reduced contaminant stream 390 is sent to the CO₂ fractionation column 400 where it is separated into an overhead gas stream 405 comprising light components including, but not limited to, one or more of N₂, O₂, or NO, and a carbon dioxide-enriched bottom stream 410.

The overhead gas stream 405 may be warmed in the main heat exchanger 360, and the warmed overhead gas stream 415 may be sent to the PSA unit 335. Alternatively, it could be sent to atmosphere, or further flue gas contaminant treating.

As discussed above, during fractionation in the CO₂ fractionation column 400, a portion of the NO may be converted to NO₂, which leaves with the carbon dioxide-enriched bottom stream 410.

The carbon dioxide-enriched bottom stream 410 from the CO₂ fractionation column 400 is sent to the NOx stripping column 420 where the remaining NOx compounds are stripped from the carbon dioxide-enriched bottom stream 410. The stripping column overhead stream 425 comprises gaseous carbon dioxide and is depleted of NOx compounds. It is the gaseous carbon dioxide product stream. As discussed above, it can be used to cool the upstream process if the temperature specification for the gaseous carbon dioxide product is sufficiently high.

The stripping column bottom stream 430, which is enriched in NOx compounds, is typically 0.1-5 mole percent NOx, and more often 0.2-1 mole % NOx. This stream may be recycled to the NOx removal zone 385 for concentration of the NOx and recovery of the CO₂, or to a flue gas generation unit (not shown) for destruction of the NOx and recovery of the CO₂.

The off gas stream 345 from the PSA unit 335 is sent to a flue gas expander 435, and the cooled expanded flue gas stream 440 is sent to the main heat exchanger 360. The warmed expanded flue gas stream 445 can be further treated and/or released to the atmosphere.

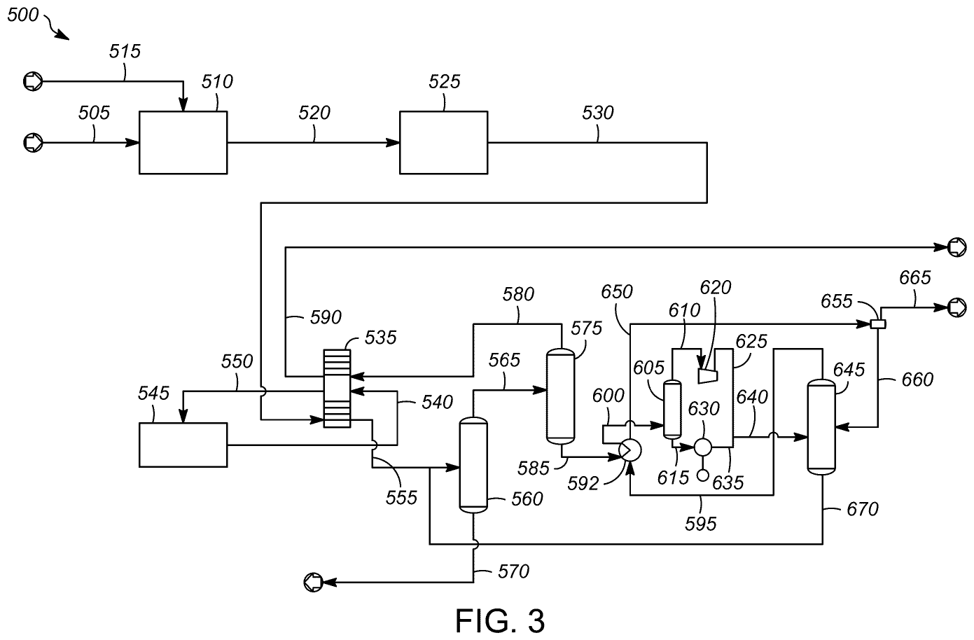

FIG. 3 illustrates one embodiment of a process 500 for producing a liquid carbon dioxide stream with reduced level of NOx compounds. A flue gas (or other gas) feed stream 505 comprises carbon dioxide, one or more NOx compounds, and one or more of nitrogen, oxygen, water and argon. The flue gas feed stream 505 may be sent to a quench column 510 where it is cooled with quench stream 515 in a quench column. The quench stream 515 can be any suitable quench stream as known to those of skill in the art. Suitable quench streams include, but are not limited to, water, caustic, or combinations thereof.

The quenched flue gas stream 520 is sent to a flue gas compressor and drier 525 where it is compressed and dried to form compressed flue gas stream 530. The quenched flue gas stream 520 is compressed from a pressure in a range of 75 to 150 kPa to a pressure in the range of 2500 to 5000 kPa for the compressed flue gas stream 530.

The compressed flue gas stream 530 is sent to the main heat exchanger 535 where it is cooled with a chilled refrigerant stream 540 from refrigeration system 545. The warmed refrigerant stream 550 is returned to the refrigeration system 545.

The cooled compressed flue gas stream 555 is sent to the NOx removal zone 560 comprising one or more NOx removal columns where the majority of the NOx compounds other than NO and N₂O are removed from the cooled compressed flue gas stream 555. The reduced contaminant stream 565 comprises carbon dioxide and a reduced level of NOx compounds compared to the cooled compressed flue gas stream 555 entering the NOx removal zone 560.

The NOx-enriched bottom stream 570 is highly concentrated in NOx compounds, typically 25-75 percent by mole. The NOx-enriched bottom stream 570 may be sent for treatment including, but not limited to, nitric acid production or fertilizer production. Alternatively, it may be combined with stream 590 and be discharged to the atmosphere, sent to further contaminant treating or a pressure swing adsorption unit.

The reduced contaminant stream 565 is sent to the CO₂ fractionation column 575 where it is separated into an overhead gas stream 580 comprising light components including, but not limited to, one or more of N₂, O₂, or NO, and a carbon dioxide-enriched bottom stream 585.

The overhead gas stream 580 may be warmed in the main heat exchanger 535, and the warmed overhead gas stream 590 may be sent to atmosphere, further flue gas contaminant treating, or a pressure swing adsorption unit.

During fractionation in the CO₂ fractionation column 575, a portion of the NO may be converted to NO₂, which leaves with the carbon dioxide-enriched bottom stream 585.

The carbon dioxide-enriched bottom stream 585 from the CO₂ fractionation column 575 is warmed in heat exchanger 592 with the stripping column overhead stream 595. The warmed carbon dioxide-enriched bottom stream 600 is sent to flash drum 605 where it is separated into carbon dioxide-enriched bottom vapor stream 610 and carbon dioxide-enriched bottom liquid stream 615.

The carbon dioxide-enriched bottom vapor stream 610 is compressed in compressor 620 forming compressed carbon dioxide-enriched bottom vapor stream 625. The carbon dioxide-enriched bottom liquid stream 615 is pumped in pump 630 forming pumped carbon dioxide-enriched bottom liquid stream 635.

The compressed carbon dioxide-enriched bottom vapor stream 625 and the pumped carbon dioxide-enriched bottom liquid stream 635 can be combined, and the combined carbon dioxide-enriched bottom stream 640 is sent to the NOx stripping column 645. Alternatively, the compressed carbon dioxide-enriched bottom vapor stream 625 and the pumped carbon dioxide-enriched bottom liquid stream 635 can be sent to the NOx stripping column 645 separately.

The stripping column overhead stream 595 is heat exchanged with the carbon dioxide-enriched bottom stream 585 from the CO₂ fractionation column 575. The cooled stripping column overhead 650 is sent to overhead receiver 655.

The liquid stripping column overhead from the overhead receiver 655 can be split into first portion 660, which can be refluxed to the NOx stripping column 645, and a second portion 665, which is the carbon dioxide product stream. It can be further chilled, or it can be pumped to form supercritical carbon dioxide.

The stripping column bottom stream 670, which is enriched in NOx compounds, is typically 0.1-5 mole percent NOx, and more often 0.2-1 mole % NOx. This stream may be recycled to the NOx removal zone 560 for concentration of the NOx and recovery of the CO₂, or to a flue gas generation unit (not shown) for destruction of the NOx and recovery of the CO₂.

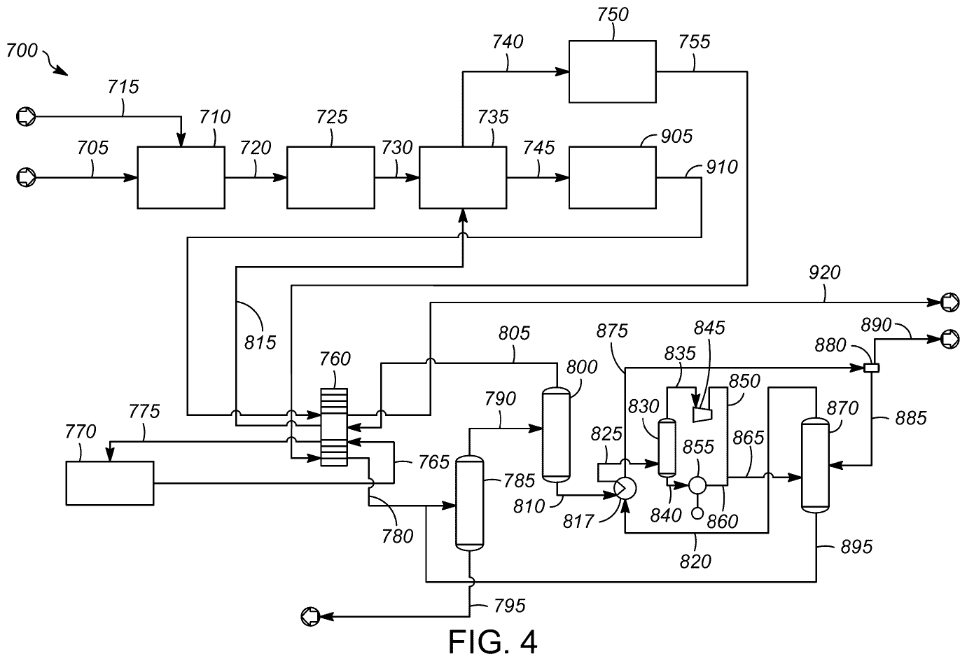

FIG. 4 illustrates a second embodiment of a process 700 for producing a carbon dioxide liquid stream with reduced level of NOx compound. The flue gas (or other gas) feed stream 705 comprises carbon dioxide, one or more NOx compounds, and one or more of nitrogen, oxygen, water and argon. The flue gas feed stream 705 may be sent to a quench column 710 where it is cooled with quench stream 715, as described above.

The quenched flue gas stream 720 is sent to a flue gas compressor 725 where it is compressed from a pressure in a range of 75 to 150 kPa to a pressure in the range of 800 to 2500 kPa.

The compressed flue gas stream 730 is sent to a CO₂ pressure swing adsorption (PSA) unit 735, which can be a standard CO₂ PSA unit or a CO₂ vacuum pressure swing adsorption (VPSA) unit, as discussed above. The compressed flue gas stream 730 is separated into a CO₂-enriched stream 740 and an off gas stream 745.

The CO₂-enriched stream 740 is sent to a compressor and dehydration unit 750 where it is compressed to a pressure in the range of 2500 to 5000 kPa and dried forming dried CO₂-enriched stream 755. Suitable dehydration units are described above.

The dried CO₂-enriched stream 755 is sent to the main heat exchanger 760 where it is cooled with a chilled refrigerant stream 765 from refrigeration system 770 forming cooled CO₂-enriched stream 780. The warmed refrigerant stream 775 is returned to the refrigeration system 770.

The cooled CO₂-enriched stream 780 is sent to the NOx removal zone 785 comprising one or more NOx removal columns where the majority of the NOx compounds other than NO and N₂O are removed. The reduced contaminant stream 790 comprises carbon dioxide and a reduced level of NOx compounds compared to the cooled CO₂-enriched stream 780 entering the NOx removal zone 785.

The NOx-enriched bottom stream 795 is highly concentrated in NOx compounds, typically 25-75 percent by mole. The NOx-enriched bottom stream 795 may be sent for treatment including, but not limited to, nitric acid production or fertilizer production. Alternatively, it may be combined with stream and sent to further contaminant treating or a pressure swing adsorption unit.

The reduced contaminant stream 790 is sent to the CO₂ fractionation column 800 where it is separated into an overhead gas stream 805 comprising light components including, but not limited to, one or more of N₂, O₂, or NO, and a carbon dioxide-enriched bottom stream 810.

The overhead gas stream 805 may be warmed in the main heat exchanger 760, and the warmed overhead gas stream 815 may be sent to the PSA unit 735. Alternatively, it could be sent to atmosphere, or further flue gas contaminant treatment.

As discussed above, during fractionation in the CO₂ fractionation column 800, a portion of the NO may be converted to NO₂, which leaves with the carbon dioxide-enriched bottom stream 810.

The carbon dioxide-enriched bottom stream 810 from the CO₂ fractionation column 800 is warmed in heat exchanger 817 with the stripping column overhead stream 820. The warmed carbon dioxide-enriched bottom stream 825 is sent to flash drum 830 where it is separated into carbon dioxide-enriched bottom vapor stream 835 and carbon dioxide-enriched bottom liquid stream 840.

The carbon dioxide-enriched bottom vapor stream 835 is compressed in compressor 845 forming compressed carbon dioxide-enriched bottom vapor stream 850. The carbon dioxide-enriched bottom liquid stream 840 is pumped in pump 855 forming pumped carbon dioxide-enriched bottom liquid stream 860.

The compressed carbon dioxide-enriched bottom vapor stream 850 and the pumped carbon dioxide-enriched bottom liquid stream 860 can be combined, and the combined carbon dioxide-enriched bottom stream 865 is sent to the NOx stripping column 870. Alternatively, the compressed carbon dioxide-enriched bottom vapor stream 850 and the pumped carbon dioxide-enriched bottom liquid stream 860 can be sent to the NOx stripping column 870 separately.

The stripping column overhead stream 820 is heat exchanged with the carbon dioxide-enriched bottom stream 810 from the CO₂ fractionation column 800. The cooled stripping column overhead 875 is sent to overhead receiver 880.

The liquid stripping column overhead from the overhead receiver 880 can be split into first portion 885, which can be refluxed to the NOx stripping column 870, and a second portion 890, which is the liquid carbon dioxide product stream. It can be further chilled, or it can be pumped to form supercritical carbon dioxide.

The stripping column bottom stream 895, which is enriched in NOx compounds, is typically 0.1-5 mole percent NOx, and more often 0.2-1 mole % NOx. This stream may be recycled to the NOx removal zone 785 for concentration of the NOx and recovery of the CO₂, or to a flue gas generation unit (not shown) for destruction of the NOx and recovery of the CO₂.

The off gas stream 745 from the PSA unit 735 is sent to a flue gas expander 905, and the cooled expanded flue gas stream 910 is sent to the main heat exchanger 760. The warmed expanded flue gas stream 920 can be further treated and/or released to the atmosphere.

### SPECIFIC EMBODIMENTS

While the following is described in conjunction with specific embodiments, it will be understood that this description is intended to illustrate and not limit the scope of the preceding description and the appended claims.

A first embodiment of the invention is a process for recovery of carbon dioxide from a flue gas stream and removal of NOx compounds from the recovered carbon dioxide comprising compressing a flue gas feed stream forming a compressed flue gas stream, wherein the flue gas feed stream comprises carbon dioxide and a NOx compound; removing at least a portion of the NOx compound from the compressed flue gas feed stream in a NOx removal zone comprising a NOx removal column forming a reduced contaminant stream wherein a level of the NOx compound in the reduced contaminant stream is less than a level of the NOx compound in the compressed flue gas stream; fractionating the reduced contaminant stream in a CO₂ fractionation column into a carbon dioxide-enriched bottom stream comprising carbon dioxide and the NOx compound and an overhead gas stream enriched in light components comprising one or more of N₂, O₂, N₂O or NO; stripping at least a portion of the NOx compound from the carbon dioxide-enriched bottom stream from the CO₂ fractionation column in a NOx stripping column forming a stripping column overhead stream comprising carbon dioxide and depleted of the NOx compound and a stripping column bottom stream enriched in the NOx compound. An embodiment of the invention is one, any or all of prior embodiments in this paragraph up through the first embodiment in this paragraph further comprising separating the stripping column overhead stream into an overhead liquid stream and an overhead gas stream; and refluxing the overhead liquid stream to the NOx stripping column; wherein the overhead gas stream comprises a gaseous carbon dioxide product stream. An embodiment of the invention is one, any or all of prior embodiments in this paragraph up through the first embodiment in this paragraph further comprising compressing at least a portion of the carbon dioxide-enriched bottom stream from the CO₂ fractionation column before introducing the carbon dioxide-enriched bottom stream to the NOx stripping column. An embodiment of the invention is one, any or all of prior embodiments in this paragraph up through the first embodiment in this paragraph further comprising heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream. An embodiment of the invention is one, any or all of prior embodiments in this paragraph up through the first embodiment in this paragraph further comprising separating the warmed carbon dioxide-enriched bottom stream into a liquid carbon dioxide-enriched bottom stream and a vapor carbon dioxide-enriched bottom stream; and wherein compressing the at least the portion of the carbon dioxide-enriched bottom stream comprises compressing the vapor carbon dioxide-enriched bottom stream. An embodiment of the invention is one, any or all of prior embodiments in this paragraph up through the first embodiment in this paragraph further comprising introducing the liquid carbon dioxide-enriched bottom stream and the compressed carbon dioxide-enriched bottom stream to the NOx stripping column. An embodiment of the invention is one, any or all of prior embodiments in this paragraph up through the first embodiment in this paragraph further comprising pumping the liquid carbon dioxide-enriched bottom stream. An embodiment of the invention is one, any or all of prior embodiments in this paragraph up through the first embodiment in this paragraph further comprising heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream; refluxing a first portion of the cooled stripping column overhead stream from the NOx stripping column to the NOx stripping column; and wherein a second portion of the cooled stripper column overhead stream comprises a liquid carbon dioxide product stream. An embodiment of the invention is one, any or all of prior embodiments in this paragraph up through the first embodiment in this paragraph further comprising cooling the stripping column overhead stream from the NOx stripping column forming a cooled stripping column overhead stream; and wherein the cooled stripping column overhead stream comprises a liquid carbon dioxide product stream. An embodiment of the invention is one, any or all of prior embodiments in this paragraph up through the first embodiment in this paragraph further comprising chilling the liquid carbon dioxide product stream; or pumping the liquid carbon dioxide product stream to form a supercritical carbon dioxide product stream; or both. An embodiment of the invention is one, any or all of prior embodiments in this paragraph up through the first embodiment in this paragraph further comprising recycling the stripping column bottom stream to the NOx removal zone or a flue gas generation unit. An embodiment of the invention is one, any or all of prior embodiments in this paragraph up through the first embodiment in this paragraph wherein the CO₂ removal zone comprises a CO₂ pressure swing adsorption (PSA) unit and further comprising separating the compressed flue gas feed stream in a CO₂ pressure swing adsorption (PSA) unit to form a CO₂-enriched stream, and an off gas stream before removing the at least a portion of the NOx compound from the compressed flue gas feed stream; and compressing the CO₂-enriched stream in a compressor forming a compressed CO₂-enriched stream; wherein removing the at least a portion of the NOx compound from the compressed flue gas feed stream comprises removing the at least a portion of the NOx compound from the compressed CO₂-enriched stream.

A second embodiment of the invention is a process for recovery of carbon dioxide from a flue gas stream and removal of NOx compounds from the recovered carbon dioxide comprising compressing a flue gas feed stream forming a compressed flue gas stream, wherein the flue gas feed stream comprises carbon dioxide and a NOx compound; removing at least a portion of the NOx compound from the compressed flue gas feed stream in a NOx removal zone comprising a NOx removal column forming a reduced contaminant stream wherein a level of the NOx compound in the reduced contaminant stream is less than a level of the NOx compound in the compressed flue gas stream and a NOx-enriched bottom stream; fractionating the reduced contaminant stream in a CO₂ fractionation column into a carbon dioxide-enriched bottom stream comprising carbon dioxide and the NOx compound and an overhead gas stream enriched in light components comprising one or more of N₂, N₂O, O₂, or NO; stripping at least a portion of the NOx compound from the carbon dioxide-enriched bottom stream from the CO₂ fractionation column in a NOx stripping column forming a stripping column overhead stream comprising carbon dioxide and depleted of the NOx compound and a stripping column bottom stream enriched in the NOx compound; treating the NOx-enriched bottom stream from the NOx removal zone; and recycling the stripping column bottom stream to the NOx removal zone or a flue gas generation unit. An embodiment of the invention is one, any or all of prior embodiments in this paragraph up through the second embodiment in this paragraph further comprising separating the stripping column overhead stream into an overhead liquid stream and an overhead gas stream; and refluxing the overhead liquid stream to the NOx stripping column; wherein the overhead gas stream comprises a gaseous carbon dioxide product stream. An embodiment of the invention is one, any or all of prior embodiments in this paragraph up through the second embodiment in this paragraph further comprising compressing at least a portion of the carbon dioxide-enriched bottom stream from the CO₂ fractionation column before introducing the carbon dioxide-enriched bottom stream to the NOx stripping column. An embodiment of the invention is one, any or all of prior embodiments in this paragraph up through the second embodiment in this paragraph further comprising heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream; separating the warmed carbon dioxide-enriched bottom stream into a liquid carbon dioxide-enriched bottom stream and a vapor carbon dioxide-enriched bottom stream, and compressing the vapor carbon dioxide-enriched bottom stream; introducing the liquid carbon dioxide-enriched bottom stream and the compressed carbon dioxide-enriched bottom stream to the NOx stripping column. An embodiment of the invention is one, any or all of prior embodiments in this paragraph up through the second embodiment in this paragraph further comprising pumping the liquid carbon dioxide-enriched bottom stream. An embodiment of the invention is one, any or all of prior embodiments in this paragraph up through the second embodiment in this paragraph further comprising heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream; refluxing a first portion of the cooled stripping column overhead stream from the NOx stripping column to the NOx stripping column; and wherein a second portion of the cooled stripper column overhead stream comprises a liquid carbon dioxide product stream. An embodiment of the invention is one, any or all of prior embodiments in this paragraph up through the second embodiment in this paragraph further comprising chilling the liquid carbon dioxide product stream; or pumping the liquid carbon dioxide product stream to form a supercritical carbon dioxide product stream; or both. An embodiment of the invention is one, any or all of prior embodiments in this paragraph up through the second embodiment in this paragraph wherein the CO₂ removal zone comprises a CO₂ pressure swing adsorption (PSA) unit and further comprising separating the compressed flue gas feed stream in a CO₂ pressure swing adsorption (PSA) unit to form a CO₂-enriched stream, and an off gas stream before removing the at least a portion of the NOx compound from the compressed flue gas feed stream; and compressing the CO₂-enriched stream in a compressor forming a compressed CO₂-enriched stream; wherein removing the at least a portion of the NOx compound from the compressed flue gas feed stream comprises removing the at least a portion of the NOx compound from the compressed CO₂-enriched stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for recovery of carbon dioxide from a flue gas stream and removal of NOx compounds from the recovered carbon dioxide comprising:
compressing a flue gas feed stream forming a compressed flue gas stream, wherein the flue gas feed stream comprises carbon dioxide and a NOx compound;
removing at least a portion of the NOx compound from the compressed flue gas feed stream in a NOx removal zone comprising a NOx removal column forming a reduced contaminant stream wherein a level of the NOx compound in the reduced contaminant stream is less than a level of the NOx compound in the compressed flue gas stream;
fractionating the reduced contaminant stream in a CO₂ fractionation column into a carbon dioxide-enriched bottom stream comprising carbon dioxide and the NOx compound and an overhead gas stream enriched in light components comprising one or more of N₂, O₂, N₂O or NO; and
stripping at least a portion of the NOx compound from the carbon dioxide-enriched bottom stream from the CO₂ fractionation column in a NOx stripping column forming a stripping column overhead stream comprising carbon dioxide and depleted of the NOx compound and a stripping column bottom stream enriched in the NOx compound.

2. The process of claim 1 further comprising:
separating the stripping column overhead stream into an overhead liquid stream and an overhead gas stream; and
refluxing the overhead liquid stream to the NOx stripping column;
wherein the overhead gas stream comprises a gaseous carbon dioxide product stream.

3. The process of claim 1 further comprising:
compressing at least a portion of the carbon dioxide-enriched bottom stream from the CO₂ fractionation column before introducing the carbon dioxide-enriched bottom stream to the NOx stripping column.

4. The process of claim 3 further comprising:
heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream.

5. The process of claim 4 further comprising:
separating the warmed carbon dioxide-enriched bottom stream into a liquid carbon dioxide-enriched bottom stream and a vapor carbon dioxide-enriched bottom stream; and
wherein compressing the at least the portion of the carbon dioxide-enriched bottom stream comprises compressing the vapor carbon dioxide-enriched bottom stream.

6. The process of claim 5 further comprising:
introducing the liquid carbon dioxide-enriched bottom stream and the compressed carbon dioxide-enriched bottom stream to the NOx stripping column.

7. The process of claim 5 further comprising:
pumping the liquid carbon dioxide-enriched bottom stream.

8. The process of claim 3 further comprising:
heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream;
refluxing a first portion of the cooled stripping column overhead stream from the NOx stripping column to the NOx stripping column; and
wherein a second portion of the cooled stripper column overhead stream comprises a liquid carbon dioxide product stream.

9. The process of claim 3 further comprising:
cooling the stripping column overhead stream from the NOx stripping column forming a cooled stripping column overhead stream; and
wherein the cooled stripping column overhead stream comprises a liquid carbon dioxide product stream.

10. The process of claim 9 further comprising:
chilling the liquid carbon dioxide product stream; or
pumping the liquid carbon dioxide product stream to form a supercritical carbon dioxide product stream; or
both.

11. The process of claim 1 further comprising:
recycling the stripping column bottom stream to the NOx removal zone or a flue gas generation unit.

12. The process of claim 1 wherein the CO₂ removal zone comprises a CO₂ pressure swing adsorption (PSA) unit and further comprising:
separating the compressed flue gas feed stream in a CO₂ pressure swing adsorption (PSA) unit to form a CO₂-enriched stream, and an off gas stream before removing the at least a portion of the NOx compound from the compressed flue gas feed stream; and
compressing the CO₂-enriched stream in a compressor forming a compressed CO₂-enriched stream;
wherein removing the at least a portion of the NOx compound from the compressed flue gas feed stream comprises removing the at least a portion of the NOx compound from the compressed CO₂-enriched stream.

13. A process for recovery of carbon dioxide from a flue gas stream and removal of NOx compounds from the recovered carbon dioxide comprising:
compressing a flue gas feed stream forming a compressed flue gas stream, wherein the flue gas feed stream comprises carbon dioxide and a NOx compound;
removing at least a portion of the NOx compound from the compressed flue gas feed stream in a NOx removal zone comprising a NOx removal column forming a reduced contaminant stream wherein a level of the NOx compound in the reduced contaminant stream is less than a level of the NOx compound in the compressed flue gas stream and a NOx-enriched bottom stream;
fractionating the reduced contaminant stream in a CO₂ fractionation column into a carbon dioxide-enriched bottom stream comprising carbon dioxide and the NOx compound and an overhead gas stream enriched in light components comprising one or more of N₂, N₂O, O₂, or NO;
stripping at least a portion of the NOx compound from the carbon dioxide-enriched bottom stream from the CO₂ fractionation column in a NOx stripping column forming a stripping column overhead stream comprising carbon dioxide and depleted of the NOx compound and a stripping column bottom stream enriched in the NOx compound;
treating the NOx-enriched bottom stream from the NOx removal zone; and
recycling the stripping column bottom stream to the NOx removal zone or a flue gas generation unit.

14. The process of claim 13 further comprising:
separating the stripping column overhead stream into an overhead liquid stream and an overhead gas stream; and
refluxing the overhead liquid stream to the NOx stripping column;
wherein the overhead gas stream comprises a gaseous carbon dioxide product stream.

15. The process of claim 13 further comprising:
compressing at least a portion of the carbon dioxide-enriched bottom stream from the CO₂ fractionation column before introducing the carbon dioxide-enriched bottom stream to the NOx stripping column.

16. The process of claim 13 further comprising:
heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream;
separating the warmed carbon dioxide-enriched bottom stream into a liquid carbon dioxide-enriched bottom stream and a vapor carbon dioxide-enriched bottom stream;
compressing the vapor carbon dioxide-enriched bottom stream; and
introducing the liquid carbon dioxide-enriched bottom stream and the compressed carbon dioxide-enriched bottom stream to the NOx stripping column.

17. The process of claim 16 further comprising:
pumping the liquid carbon dioxide-enriched bottom stream.

18. The process of claim 13 further comprising:
heat exchanging the carbon dioxide-enriched bottom stream from the CO₂ fractionation column with the stripping column overhead stream from the NOx stripping column forming a warmed carbon dioxide-enriched bottom stream and a cooled stripping column overhead stream before compressing the at least the portion of the carbon dioxide-enriched bottom stream; and
refluxing a first portion of the cooled stripping column overhead stream from the NOx stripping column to the NOx stripping column;
wherein a second portion of the cooled stripper column overhead stream comprises a liquid carbon dioxide product stream.

19. The process of claim 18 further comprising:
chilling the liquid carbon dioxide product stream; or
pumping the liquid carbon dioxide product stream to form a supercritical carbon dioxide product stream; or
both.

20. The process of claim 13 wherein the CO₂ removal zone comprises a CO₂ pressure swing adsorption (PSA) unit and further comprising:
separating the compressed flue gas feed stream in a CO₂ pressure swing adsorption (PSA) unit to form a CO₂-enriched stream, and an off gas stream before removing the at least a portion of the NOx compound from the compressed flue gas feed stream; and
compressing the CO₂-enriched stream in a compressor forming a compressed CO₂-enriched stream;
wherein removing the at least a portion of the NOx compound from the compressed flue gas feed stream comprises removing the at least a portion of the NOx compound from the compressed CO₂-enriched stream.
